(19) United States
(12) Patent Application Publication
(10) Pub. No.: US 2012/0111510 A1
(43) Pub. Date: May 10, 2012

(54) Device for partitioning spaces

(76) Inventors: Mark Chak, Brooklyn, NY (US); Alexander Chak, Brooklyn, NY (US)

(21) Appl. No.: 12/927,099

(22) Filed: Nov. 8, 2010

(51) Int. Cl. E06B 11/06

(52) U.S. Cl. 160/368.1

(57) ABSTRACT

A device for partitioning a space, particularly for reducing energy consumption, having a partition which is installable in a space and limits a part of the space in which heating or cooling is carried out; and an element for attaching the partition to elements of the space.

### BACKGROUND OF THE INVENTION

The present invention relates to a device for partitioning tables.

It is advantageous to subdivide spaces, for example inside vehicles. If in a vehicle only the front seats are occupied, then the air conditioning or heating of a whole inner space of the vehicle involves a waste of energy and fuel.

It is therefore advisable to delimit the subspace accommodating only the front seats for energy/fuel saving purposes. Also partitions of other spaces as advisable as well.

### SUMMARY OF THE INVENTION

Accordingly it is an object of the present invention to provide a new device for partitioning tables, which is a further improvement.

In keeping with these object, the present invention resides in a device for partitioning a space, particularly for reducing energy consumption for cooling or heating the space, comprising a partition which is installable in a space and limits a part of the space in which heating or cooling is carried out; and means for attaching the partition to elements of the space.

Another feature of the present invention resides in that said partition includes a film installable in the space, and said means attaching the film to a bordering structure of the space.

A further feature of the invention resides in that said attaching means includes a VELCRO element having one member attachable to the bordering structure and another member attached to the film, with the members releasably connectable with one another by a VELCRO interengagement.

A further feature of the invention resides in that the VELCRO has one adhesive layer, provided on said one member and attaching it to the bordering structure, and another adhesive layer provided on the other member and attaching it to said film.

A further feature of the invention resides in that a rod is attachable to a ceiling of the space, and a plurality of rings attached to said partition and movable over said rod.

A further feature of the invention resides in that said attaching means can include zipper means.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 are views showing two embodiments of a device for partitioning tables of the present invention;

FIG. 3 is a view showing a film of the inventive device with attaching means;

FIG. 4 is a view showing a cross-section of a attaching areas of the inventive device; and

FIG. 5 shows a further embodiment of a device for partitioning tables of the present invention.

### DESCRIPTION OF THE PREFERRED EMBODIMENTS

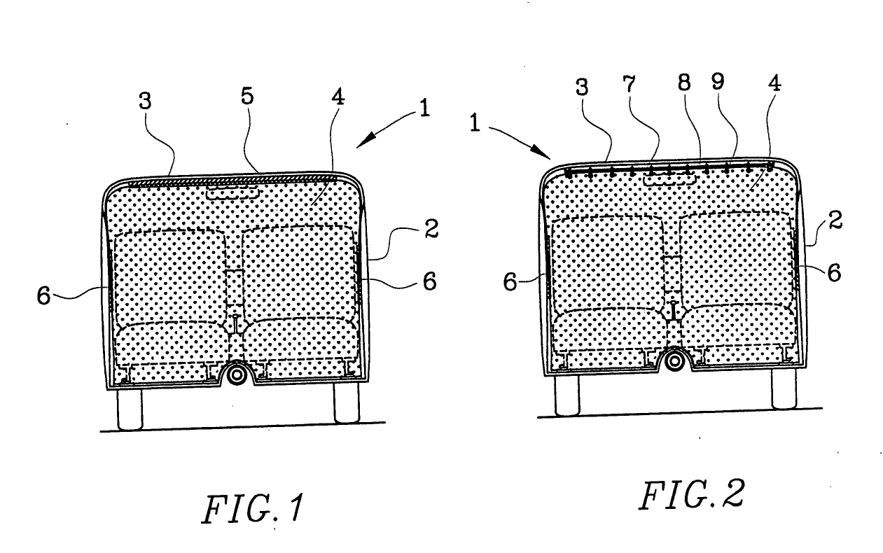

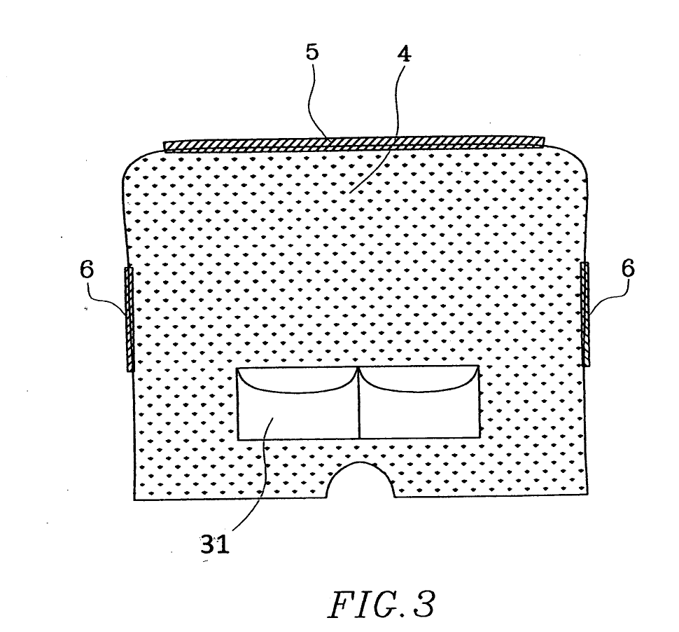

A device for partitioning spaces shown in FIG. 1 is provided, as an example inside a vehicle. It includes a divider formed as a film 4, which can be a plastic film, transparent, translucent or opaque. The film can be air-impermeable to prevent penetration of air from one subspace to another.

The film 4 is located in a car space 1 behind front seats and is attached to a ceiling 3 and two side wall 2 of the vehicle. Therefore only front outlets of the air-conditioning and/or heating can be open in the vehicle, to condition only the front subspace in the vehicle.

The film 4 is attached, for example, by a VELCRO connections 5, 6. For this purpose a VELCRO element is used, which has a layer with engaging projections provided on one side and an adhesive provided on an opposite side and temporarily covered by a cover sheet.

Two pieces are cut from the VELCRO element, and the cover sheet is removed. One piece 11 with its adhesive layer 12 is attached for example to a ceiling, while the other piece 13 is attached by its adhesive layer 14 to the film. When the film has to be installed in the inner space, the pieces 11 and 13 are pressed toward one another so that their engaging projections 15 and 16 engages each other, and thereby the film 4 is attached, for example, to the ceiling.

It is possible to sealingly connect the film 4 to the ceiling and also to the side walls, for example by the VELCRO connected as shown in FIG. 1.

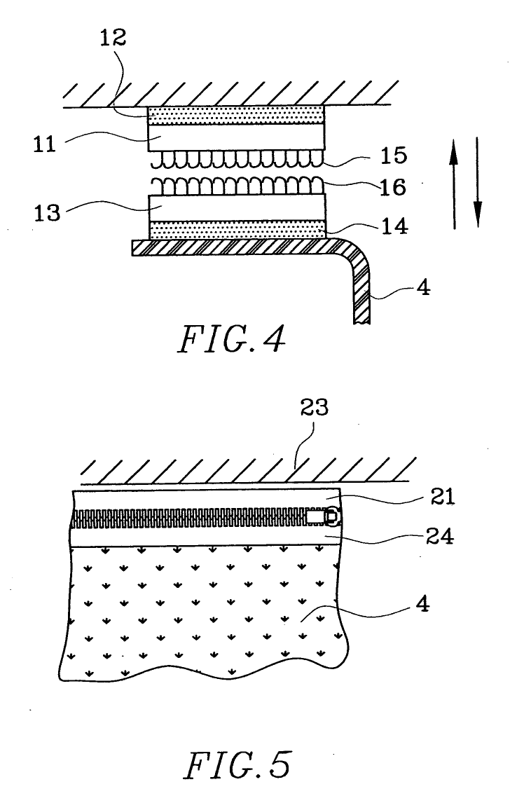

It is however also possible to sealingly connect the film 4 only to the side walls, while in the top area 7 the film 4 can be provided with rings 9 displaceable transversely over a horizontal rod 8 attached to the ceiling of the vehicle, as shown in FIG. 4.

In this case one side or both sides of the film 4 can be disconnected from the wall (walls) of the vehicle, and the film 4 can be displaced to one side to occupy a small width in a non-use position.

Also, a lower edge of the film 4 can be sealingly connected to the floor of the vehicle, for example also by the VELCRO connection.

As shown in FIG. 5 also a zipper connection can be used for connecting the film to the walls and/or ceiling and/or floor to the vehicle.

In this case one part 21 of the zipper can be connected, for example by an adhesive connection to the ceilings 23, while the other part 24 of the zipper is connected by another an adhesive connection to the film 4.

When necessary, the zipper is opened to remove the film, or closed to install the film in the corresponding space.

Also, pockets 31 can be provided on the film, to hold articles deposited by a driver or a passenger.

It is believed to be clear that not only the spaces within vehicles, but also residential spaces, office spaces, industrial spaces, etc. . . . can be subdivided into smaller subspaces with the use of the inventive device.

It will be understood that each of the elements described above, or two or more together, may also find a useful application in other types of constructions differing from the type described above.

While the invention has been illustrated and described as embodied in a device for partitioning tables, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for partitioning a space, particularly for reducing energy consumption, comprising a divider formed as a film which is installable in a space and limits a part of the space in which heating or cooling is carried out;
and means for attaching the partition to a bordering structure of the space, wherein said means for attaching attach the film to a ceiling, side walls and a floor of the bordering structure, wherein said attaching means includes a VELCRO element having one member attachable to side walls of the space and another member attached to the side areas of the film, with the members releasably connectable with one another by a VELCRO interengagement, wherein said attaching means also include a rod attachable to a ceiling of the space, and a plurality of rings attached to a top area of said film and movable over said rod.

2-6. (canceled)

7. A device as defined in claim 6, further comprising one adhesive layer provided on said one member and attaching it to the bordering structure, and another adhesive layer provided on the other member and attaching it to said film.

8. (canceled)

9. A device for partitioning a space, particularly for reducing energy consumption, comprising a divider formed as a film which is installable in a space and limits a part of the space in which heating or cooling is carried out; and means for attaching the partition to a bordering structure of the space, wherein said means for attaching attach the film to a ceiling, side walls and a floor of the bordering structure, wherein said attaching means includes a VELCRO element having one member attachable to the side walls of the space and another member attached to the side areas of the film, with the members releasably connectable with one another by a VELCRO interengagement, wherein said attaching means also include zipper means attaching a top area of the film to the ceiling of the space.

10. A device as defined in claim 1, wherein said film is a plastic film selected from the group consisting of transparent, translucent, and opaque film.

11. A device as defined in claim 1, wherein said film is provided with pockets for articles deposited by a driver and a passenger.
